(19) United States
(12) Patent Application Publication
(10) Pub. No.: US 2005/0234169 A1
(43) Pub. Date: Oct. 20, 2005

(54) Releasable adhesive composition

(76) Inventors: Jang Soon Kim, Daejeon (KR); Woo Ha Kim, Gangwon-do (KR); Jae Gwan Lee, Daejeon (KR); Suk Ky Chang, Daejeon (KR); Wook Kim, Seoul (KR); Geun Hee Lee, Chungcheongbuk-do (KR); Byoung Soo Lee, Seoul (KR)

Correspondence Address: MCKENNA LONG & ALDRIDGE LLP, 1900 K STREET, NW, WASHINGTON, DC, 20006, US

(21) Appl. No.: 11/051,639

(22) Filed: Jan. 27, 2005

(30) Foreign Application Priority Data
Jan. 28, 2004 (KR) 10-2004-0005386

(51) Int. Cl. C08G 63/02

(52) U.S. Cl. 524/284; 524/556; 524/430

(57) ABSTRACT

The present invention provides an adhesive composition comprising an adhesive polymer resin and an organic crystalline material having a higher melting point than the maximum acceptable operating temperature of products where the adhesive is used, as well as an adhesive sheet prepared therefrom. The adhesive composition and adhesive sheet of the present invention maintain excellent adhesion strength at their use temperature and show a rapid reduction in adhesion at a higher temperature than the melting point of the organic crystalline material so as to allow release from substrates.

### TECHNICAL FIELD

The present invention relates to a releasable adhesive composition, and more particularly, to an adhesive composition which can be easily released at a higher temperature than the maximum acceptable operating temperature of products where the adhesive is used, as well as an adhesive sheet prepared therefrom.

### BACKGROUND ART

With the development of IT industries, various electrical and electronic products including display products tend to be composed of various materials. These electrical or electronic products are generally made by the combination of such materials as metals, ceramics and plastics, and in order to assemble such materials into a product, adhesives with various thickness and performance are used so as to allow these materials to function smoothly. In addition to bonding different materials with each other, the adhesives applied to electronic products sometimes need to have insulating, adiabatic, heat dissipating, antistatic or electromagnetic wave shielding characteristics, etc., in order to allow the bonded materials to do their intrinsic functions smoothly. Accordingly, a development of adhesive or bonding materials satisfying such need is now required.

Meanwhile, when the detachment between electrical or electronic parts is required either in the disposal of the electrical or electronic products, or in the reprocessing operations due to the misassembling of products in manufacturing processes, it is necessary to release and remove the adhesive without causing damaging to the parts. In the case of small adhesive area, it is relatively easy to release the adhesive in the detachment process, but when the adhesive is used in large-area devices such as plasma displays, it is very difficult to release the adhesive in the detachment process because of large adhesive area. Particularly in the case of plasma displays, an adhesive attaches very hard glass substrate to a heat dissipating substrate (heat sink) generally made of Al, and thus, once the two substrates are bonded by the adhesive, it is very difficult to separate the substrates each other from the adhesive.

In order to conduct operations for separating the substrates from the adhesive, electronic manufacturers utilize methods, for example, comprising heating the glass and heat sink attached by the adhesive to a high temperature and inserting wires between the two substrates to separate the substrates from the adhesive. In this case, however, there are problems that all the processes should be performed by hand and a mistaken operation in the process causes damages to the substrates, thus making it difficult to recycle highly expensive plasma display glass. Accordingly, there is a need for the development of releasable adhesives which allow easy separation of substrates attached to each other by the adhesives, without special hand operations or damages.

In the prior art relating to releasable adhesives, an adhesive containing a foaming agent to make its release easy is disclosed in, for example, Japanese Patent Laid-Open Publication No. Hei 5-279636. In the case of this adhesive containing the foaming agent, the expansion of the foaming agent by heat treatment allows easy separation of each substrates attached to each other by the adhesive.

Also known are an adhesive containing a side chain-crystallizable polymer (Japanese Patent Laid-Open Publication No. Hei 9-249858) and an adhesive containing a heat-curable compound (Japanese Patent Laid-Open Publication No. Hei 10-25456). In the case of the adhesive containing a side chain-crystallizable polymer disclosed in Japanese Patent Laid-Open Publication No. Hei 9-249858, the polymer is crystallized at a temperature of about less than 15° C., and so under this temperature the adhesion strength of the adhesive reduces, which makes the release of the adhesive easy. The adhesive disclosed in Japanese Patent Laid-Open Publication No. Hei 10-25456 is cured by heating to about 50-150° C., resulting in a reduction in its adhesion strength. In addition, Japanese Patent Laid-Open Publication No. Hei 1-249877 discloses a UV-curable adhesive which is cured by UV, resulting in a reduction in its adhesion strength. These adhesives, which utilize the relation between the curing of the adhesives and changes of the adhesion strength in the adhesives, are applied mainly to adhesive tapes for semiconductor dicing.

However, the above-described adhesives all have a problem that they are released at relatively low temperatures. Particularly, the UV-curable adhesive has problems that it requires much cost in its application and cannot be applied to UV-impermeable materials. And thus they have many limitations in the application as an adhesive for such materials as generating heat, for example, heat-dissipating sheets of electronic products.

Meanwhile, Japanese Patent Laid-Open Publication No. Hei 10-316953 discloses a thermally conductive pressure-sensitive adhesive which contains a plasticizer with a boiling point of more than 150° C. and has high adhesion strength during its use, but shows releasability after its use. However, this adhesive is so designed that it can have relatively weak adhesion by the addition of the plasticizer.

Recently, adhesives applied to electrical/electronic products with reprocessability are required to show excellent adhesion strength during the use of the electrical/electronic products and excellent releasability during the separation of the various parts from the electrical/electronic products, and to provide various properties, for example, thermal conductivity, electrical conductivity, foamability, antistatic and electromagnetic shielding properties, during the operation of the electrical/electronic products. For example, an adhesive for application to heat-dissipating sheets is necessarily required to have excellent durability at high temperature and to transfer heat well so as to perform a heat-dissipating function. Particularly, an adhesive for the use of attaching glass and an aluminum heat sink to each other in the plasma display panel needs to maintain good adhesion at a temperature suitable for its use and to have excellent releasability so as to allow expensive glass for plasma displays to be separated from a heat sink safely without defects in the process of disposal or reprocessing operations caused by inferior products.

However, there is still no development of such a releasable adhesive as being capable of providing the above-described characteristics and excellent reprocessability.

### DISCLOSURE OF THE INVENTION

Accordingly, there is an urgent need for the development of an adhesive which shows high adhesion strength and durability at the operating temperature of the electrical/electronic products and can be released easily when the parts of electrical/electronic products are separated from each other. Namely, there is a need for an adhesive which has preferable adhesive properties required in various electronic products, such as adhesion and durability, and at the same time, can be easily released under a certain condition.

The present inventors have found that, when an organic crystalline material with a higher melting temperature than the maximum acceptable operating temperature of products where an adhesive is used is added to an adhesive composition comprising an adhesive polymer resin, the adhesion strength, functionality and durability of the adhesive can be maintained so that the adhesive can have high adhesion strength below the acceptable operating temperature of the products but show low adhesion strength at a higher temperature than the melting point of the organic crystalline material so as to allow easy release of the adhesive from the substrates.

Therefore, it is an object of the present invention to provide a releasable adhesive composition.

To achieve the above object, the present invention provides an adhesive composition comprising an adhesive polymer resin and an organic crystalline material having a higher melting point than the maximum acceptable operating temperature of products where the adhesive is used.

Preferably, the adhesive polymer resin is an acrylic polymer resin.

Accordingly, an adhesive composition according to a specific embodiment of the present invention comprises the following:
a) an acrylic polymer resin;
b) a functional filler; and
c) an organic crystalline material having a higher melting point than the maximum acceptable operating temperature of products where the adhesive is used.

In another embodiment, the present invention provides an adhesive sheet prepared by applying the adhesive composition of the present invention to one or both sides of a sheet.

As used herein, the terms “adhesive” and “adhesive composition” can be used in the same meaning.

Hereinafter, the present invention will be described in detail.

The adhesive composition according to the present invention is characterized by comprising an organic crystalline material having a higher melting point than the maximum acceptable temperature of products where the adhesive is used.

As used herein, the term “organic crystalline material” means an organic material which can possess a crystalline property or configuration at a lower temperature than its melting point. Accordingly, the organic crystalline material may lose its crystalline configuration at a higher temperature than its melting temperature so as to exist in a molten state with flowability. For reference, because organic materials are difficult to exist in a complete crystalline state, such organic materials as being capable of forming a certain crystalline configuration at a lower temperature than their melting point are generally called crystalline materials. Hereinafter, organic materials which have flowability at a higher temperature than their melting point but can form a crystalline configuration at a lower temperature than their melting point will be described as “organic crystalline materials”.

In the adhesive composition of the present invention, the organic crystalline material having a higher melting point than the maximum acceptable operating temperature of products where the adhesive is used is added at an amount of 1-50 parts by weight based on the weight of the adhesive polymer resin taken as 100 parts by weight. The addition of the organic crystalline material at an amount of less than 1 part by weight may make the release of the resulting adhesive difficult, and the addition of the organic crystalline material at an amount of more than 50 parts by weight can may the adhesive very hard, resulting in a reduction in the adhesion strength of the adhesive.

If the organic crystalline material is added to the adhesive at an amount within the above-described range, the organic crystalline material can reduce the gel content of the adhesive, which improves the wettability of the adhesion to substrates, etc., resulting in an increase in the adhesion of the adhesive in the range of the operating temperatures of products where the adhesive is used. And when the temperature of the adhesive reaches the melting point of the organic crystalline material exceeding the maximum acceptable operating temperature of products where the adhesive is used, the organic crystalline material will be molten. At this time, the molten organic crystalline material present in the adhesive will move to the interface between the adhesive and the substrates and form a liquid phase layer therebetween, thus allowing the adhesive to be released easily from the substrates.

Organic crystalline materials which can be used in the present invention have no special limitations on their components insofar as their melting point is higher than the maximum acceptable operating temperature of products where the adhesive is used. If the melting point of the organic crystalline material is lower than the maximum acceptable operating temperature of products where the adhesive is used, a problem will occur in that the durability or adhesion strength of the adhesive is deteriorated during the use of the products. Meanwhile, if the melting point of the organic crystalline material is too much higher than the maximum acceptable operating temperature of products where the adhesive is used, a temperature required to release the adhesive will be excessively increased, which adversely affects other parts constituting the products during the release of the adhesive and reduces the workability of the release operations and also causes extra energy consumption for the increase of the temperature.

Accordingly, the melting point of the organic crystalline material required in the present invention is preferably higher than the maximum acceptable operating temperature of products where the adhesive is used, but is in a temperature range at which electronic parts used together with the adhesive are not adversely affected. Specifically, the melting point of the organic crystalline material is preferably at least 10° C. higher than the maximum acceptable operating temperature of products where the adhesive is used, but is lower than a temperature from which other parts constituting the products start to be damaged. The upper limit of the preferred melting point range as described above is difficult to be determined collectively, since it varies depending on products where the adhesive is used. Any person skilled in the art may select a suitable organic crystalline material in view of the melting point of the organic crystalline material depending on the product and operating circumstances where the adhesive is applied.

For example, when the adhesive of the present invention is used in plasma displays, because the maximum acceptable operating temperature of which is about 80° C., the melting point of the organic crystalline material will preferably be 90° C. or more, and more preferably 120° C. or more in view of reliability. However, the melting point of the organic crystalline material will preferably be 200° C. or less, since an increase of the temperature to more than 200° C. in the plasma display will cause damages to circuit materials or sealing materials, etc.

Meanwhile, if the molecular weight of the organic crystalline material is excessively high, significant time will be required to melt it and to move the molten material to the interface between the adhesive and the substrates. This will make it difficult to release the adhesive within a short time at the desired temperature. Accordingly, it is preferred in the present invention that the molecular weight of the organic crystalline material is 3,000 or less, and more preferably 500 or less. However, organic crystalline materials with excessively low molecular weight generally have a lower melting point than ambient temperature, and thus, have a problem that it is difficult to provide sufficient adhesion strength to the adhesives used for the electronic products which are used at a higher temperature than ambient temperature. Accordingly, it is more preferable to use organic crystalline materials with a molecular weight of more than 50.

Also, since the size of the organic crystalline material has a connection with its melting rate, it is preferred in the present invention that the size of the organic crystalline material is in a range of 1-50 μm in particle diameter. If the organic crystalline material has too small a size of less than 1 μm in particle diameter, it will be in the form of fine powder, and thus, will have a problem that it increases the hardness of the resulting adhesive, which reduces the wettability of the adhesive, and thus reduces the adhesion strength of the adhesive. On the other hand, if the particle diameter exceeds 50 μm, there will be a problem in that the melting rate of the organic crystalline material is reduced.

Specific examples of organic crystalline materials which can be used in the present invention include, but are not limited to, 3-(hydroxyphenylphosphinyl)propanic acid (HPP; C₉H₁₁O₄P), 9,10-dihydroxy-9-oxa-10-phosphaphenanthrene-10-oxide (DOPO; C₁₂H₉O₂P) tris(3-hydroxypropyl)phosphine oxide ((HO—C₃H₆)₃PO), aromatic polyphosphoric ester oligomer (PX-200), triphenylphosphoric acid, bisphenol A, and meta-terphenyl.

The polymer adhesive resins which can be used in the present invention is not specifically limited, and any polymer adhesive resin may be used without limitations if it can be used as an adhesive in the art. Preferably, an acrylic polymer resin may be used. Preferred examples of acrylic polymer resins suitable for the adhesive polymer of the present invention include polymers obtained by copolymerizing a (meth)acrylic ester monomer having an alkyl group of 1-12 carbon atoms and a polar monomer copolymerizable with the (meth)acrylic ester monomer.

Examples of the (meth)acrylic ester monomer include, but are not limited to, butyl(meth)acrylate, hexyl(meth)acrylate, n-octyl(meth)acrylate, isooctyl (meth)acrylate, 2-ethylhexyl(meth)acrylate, and isononyl(meth)acrylate.

Also, examples of the polar monomer copolymerizable with the (meta)acrylic ester monomer include, but are not limited to, carboxylic group-containing monomers such as (meth)acrylic acid, maleic acid and fumaric acid, and nitrogen-containing monomers such as acrylamide, N-vinylpyrrolidone, and N-vinylcaprolactam. The above polar monomers generally impart cohesion to the adhesive and increase the adhesion strength of the adhesive.

The ratio of the (meth)acrylic ester monomer to the polar monomer is not specifically limited but is preferably in a range of 99-80:1-20.

In order for the adhesive composition of the present invention to possess physical properties required in products to which the adhesive is applied, the adhesive composition of the present invention may further comprise at least one filler. The filler may be selected without limitations if it does not deteriorate either the operation of the products where the adhesive is used or the properties of the adhesive. Examples of the filler include, but are not limited to, thermally conductive fillers, flame-retardant fillers, antistatic agents, foaming agents, and polymeric hollow microspheres.

In the present invention, it is preferred that the filler is used at an amount of 50-200 parts by weight to 100 parts by weight of the adhesive polymer resin.

To increase the thermal conductivity of the adhesive, for example, the thermally conductive filler may be added to the adhesive composition. Examples of thermally conductive fillers which can be used in the present invention include, but are not limited to, metal oxide, metal hydroxide, metal nitride, metal carbide, and boron compounds.

Also, the adhesive composition of the present invention may further comprise other additives, for example, a polymerization initiator, a pigment, an antioxidant, a UV stabilizer, a dispersant, a defoaming agent, a tackifier, a plasticizer, a tackifying resin, a silane coupling agent and a polishing agent.

Because the adhesive composition of the present invention may additionally contain the above-described filler or other additives without deteriorating the physical properties of the adhesive, the adhesive composition of the present invention can have physical properties required in various electronic products, such as adhesion strength and durability, and at the same time, can provide an adhesive which has excellent adhesion strength at the range of the acceptable temperatures of products where the adhesive is used, but has reduced adhesion strength at a higher temperature than the melting point of the organic crystalline material, thus allowing easy release of the adhesive from substrates.

The adhesive composition of the present invention may be prepared by a conventional method of preparing polymer adhesives.

Since the adhesive polymer resin is generally formed by the polymerization of monomers, in order to prepare the adhesive composition of the present invention, a monomer for forming the adhesive polymer resin is mixed with the organic crystalline material for imparting releasability, and if necessary, a filler and other additives for imparting functionality to the adhesive composition are also mixed, then, the mixture is polymerized. It will be understood that, during the preparation process of the adhesive composition, a polymerization initiator or a crosslinking agent, etc., may further be added.

Preferably, in order to allow the organic crystalline material and other additives including fillers to be dispersed uniformly in the adhesive composition, it is more effective that the monomer for forming the adhesive polymer resin is first pre-polymerized to form a polymer syrup, to which the organic crystalline material and fillers, etc., are added, then the mixture is stirred uniformly, and followed by polymerization and crosslinking.

As a polymerization method which can be applied for the preparation of the adhesive composition of the present invention, any polymerization method which is conventionally used in the art may used without limitations, and examples thereof include radical polymerizations, for example, solution polymerization, emulsion polymerization, suspension polymerization, photo-polymerization and bulk polymerization. Of these polymerization methods, the photo-polymerizations using a photoinitiator may preferably be applied.

In a preferred embodiment of the method for preparing the adhesive composition of the present invention, in order for the materials with relatively high density, such as organic crystalline material, filler and other additives, to be dispersed uniformly in the adhesive composition, before adding the materials with relatively high density, monomers for forming the adhesive polymer resin are first partially polymerized by bulk polymerization using a thermal initiator to prepare a polymer syrup with a viscosity of about 1,000-10,000 cps, to which the organic crystalline material and the filler, and if necessary, other additives such as a crosslinking agent and a photoinitiator, are added, then the remaining monomers are polymerized and crosslinked by irradiation with UV.

The organic crystalline material and the filler are preferably dispersed uniformly in the adhesive composition. Accordingly, it is preferred that, after the organic crystalline material, the filler, the crosslinker and the photoinitiator are added, they are sufficiently stirred so as to disperse them in the mixture, and then, the polymerization and crosslinking of the monomers are conducted by irradiation with UV.

If a crosslinking agent is used in the preparation of the present adhesive composition, the adhesion properties of the adhesive composition may be adjusted depending on the amount of the crosslinking agent. The crosslinking agent is preferably used at an amount of about 0.05-2 parts by weight to the 100 parts by weight of the adhesive polymer resin. Preferred examples of crosslinking agents which can be used in the present invention include, but are not limited to, monomeric crosslinking agents such as polyfunctional acrylates, for example, 1,6-hexanediol diacrylate, trimethylolpropane triacrylate, pentaerythritol triacrylate, 1,2-ethyleneglycol diacrylate and 1,12-dodecanediol acrylate.

If a photoinitiator is used in the preparation of the present adhesive composition, the polymerization degree of the adhesive composition can be adjusted depending on the amount of the photoinitiator. The photoinitiator is preferably used at an amount of about 0.01-2 parts by weight to the 100 parts by weight of the adhesive polymer resin. Examples of the photoinitiators which can be used in the present invention include, but are not limited to, 2,4,6-trimethylbenzoyldiphenylphosphine oxide, bis(2,4,6-trimethylbenzoyl)phenylphosphine oxide, α, α-methoxy-α-hydroxyacetophenone, 2-benzoyl-2-(dimethylamino)-1-[4-(4-morphonyl)phenyl]-1-butanone, and 2,2-dimethoxy-2-phenyl acetophenone.

The adhesive composition of the present invention may additionally contain additives, such as a pigment, an antioxidant, an UV stabilizer, a dispersant, a defoaming agent, a tackifier, a plasticizer, a tackfying resin, a silane coupling agent, and a polishing agent.

The adhesive composition of the present invention can be made into a thermally conductive adhesive sheet.

One embodiment of a method for preparing the thermally conductive, adhesive sheet of the present invention is as follows.

The monomers to form adhesive polymer resin, for example to form an acrylic polymer resin, a (meth)acrylic ester monomer having an alkyl group with 1-12 carbon atoms, and a polar monomer copolymerizable with the (meth)acrylic ester monomer, are subjected to bulk polymerization using a thermal initiator, so as to prepare a polymer syrup with a viscosity of about 1,000˜10,000 cPs. To this polymer syrup, the organic crystalline material and a thermally conductive filler and if necessary, a crosslinking agent and a photoinitiator, are added and the mixture is then stirred. Next, the mixture is applied on a sheet, after which the polymerization and crosslinking of the remaining monomers and polymer syrup are conducted by irradiation with UV, thus preparing the thermally conductive, adhesive sheet. In the process of applying the mixture on a sheet, the mixture can be applied to one or both sides of the sheet so as to prepare one-side or both-side adhesive sheet using the present adhesive composition.

Examples of the material of a sheet which can be used in the preparation of the adhesive sheet include plastics, paper, non-woven fabrics, glass and metals. Preferably, a polyethylene terephthalate (PET) film, a kind of plastic material, may be used. The adhesive sheet of the present invention may be either used directly on substrates, such as heat sinks, or provided as a portion of electronic parts.

The thickness of the adhesive sheet is not specifically limited but is preferably 50 μm-2 mm. A thickness smaller than 50 μm will cause a reduction in heat transfer contact area, thus making it difficult to perform sufficient heat transfer between a heat-generating material and a heat-dissipating sheet, and a thickness lager than 2 mm will cause an increase in the thermal resistance of the adhesive sheet and take much time to perform heat dissipation.

### BEST MODE FOR CARRYING OUT THE INVENTION

Hereinafter, preferred examples are given for a better understanding of the present invention. It is to be understood, however, that these examples are presented for illustrative purpose only, but are not construed to limit the scope of the present invention.

### EXAMPLE 1

95 parts of 2-ethylhexyl acrylate and 5 parts of polar monomer acrylic acid were partially polymerized by heating in a 1-liter glass reactor to obtain a polymer syrup with a viscosity of 2000 cPs. As used in Examples, the term “parts” means parts by weight based on the weight of the adhesive polymer resin taken as 100 parts by weight. To 100 parts of the obtained polymer syrup, 0.2 parts of Irgacure-651 (α,α-methoxy-α-hydroxyacetophenone) as a photoinitiator, and 0.65 parts of 1,6-hexanediol diacrylate (HDDA) as a crosslinking agent, were added, and the mixture was sufficiently stirred.

Next, to the mixture, 100 parts of aluminum hydroxide with a particle diameter of about 70 μm as a thermally conductive filler, and 10 parts of crystalline powdery 3-hydroxyphenyl phosphinyl propanic acid (C₉H₁₁O₄P) with a melting point of 158° C. as an organic crystalline material, were added, and the mixture was sufficiently stirred until it became uniform. This mixture was defoamed by a vacuum pump under reduced pressure and then coated onto a polyester release film to a thickness of 1 mm by knife coating. At this time, a polyester film was covered on the coating layer in order to block oxygen. Thereafter, the coating layer was irradiated with UV by means of a metal halide UV lamp for 5 minutes, thus obtaining a thermally conductive adhesive sheet.

### EXAMPLE 2

A thermally conductive adhesive sheet was obtained in the same manner as in Example 1 except that the crystalline powdery 3-hydroxyphenyl phosphinyl propanic acid (C₉H₁₁O₄P) as an organic crystalline material was used at an amount of 20 parts in place of 10 parts.

### EXAMPLE 3

A thermally conductive adhesive sheet was obtained in the same manner as in Example 1 except that 20 parts of 9,10-dihydroxy-9-oxa-10-phosphaphenanthrene-10-oxide (DOPO; C₁₂H₉O₂P) with a melting point of 120° C. was used as the organic crystalline material.

### COMPARATIVE EXAMPLE 1

A thermally conductive adhesive sheet was obtained in the same manner as in Example 1 except that any organic crystalline material was not used.

The materials used in Examples and Comparative Example are summarized in Table 1 below.

TABLE 1

| | Thermally | Diameter | Amount of | Powdery organic | Weight of powdery |
|---|---|---|---|---|---|
| | conductive | of filler | filler (parts by | crystalline | crystalline material |
| | filler | (μm) | weight) | material | (parts by weight) |
| Example 1 | Al(OH)₃ | 70 | 100 | C₉H₁₁O₄P | 10 |
| Example 2 | Al(OH)₃ | 70 | 100 | C₉H₁₁O₄P | 20 |
| Example 3 | Al(OH)₃ | 70 | 100 | C₁₂H₉O₂P | 20 |
| Comparative | Al(OH)₃ | 70 | 100 | — | — |
| Example 1 | | | | | |

[Evaluation of Physical Properties of Thermally Conductive Adhesive Sheets]

1. Peel Strength (Adhesion Strength) Test

The adhesion strength of each of the adhesive sheets prepared in Examples and Comparative Example to an aluminum in the 180° direction was measured on the basis of JISZ1541. Changes of the adhesion strength with temperatures were measured after holding at each of the measurement temperatures for at least 3 minutes.

2. Test of Thermal Conductivity

Each of the adhesive sheets prepared in Examples and Comparative Example were cut into a size of about 60 mm×120 mm, and thermal conductivity of the samples were measured with the quick thermal conductivity meter QTM-500 (Kyoto Electronics Manufacturing Co., Ltd, Japan).

The results of evaluation for the physical properties of the thermally conductive adhesive sheets prepared in Examples and Comparative Example are shown in Table 2 below.

TABLE 2

| | | | Ex- | Ex- | Comparative |
|---|---|---|---|---|---|
| | | Example 1 | ample 2 | ample 3 | Example 1 |
| Adhesion | 25° C. | 1186 | 1138 | 1001 | 467 |
| Strength at | 50° C. | 1067 | 869 | 601 | 411 |
| different | 80° C. | 561 | 526 | 305 | 369 |
| temperatures | 100° C. | 452 | 433 | 116 | 286 |
| (kg/in) | 120° C. | 303 | 310 | 0 (sep- | 297 |
| | | | | arated) | |
| | 135° C. | 292 | 242 | | 208 |
| | 145° C. | 181 | 121 | | 205 |
| | 150° C. | 65 | 0 (sep- | | 203 |
| | | | arated) | | |
| | 160° C. | 0 (separated) | 0 (sep- | | 198 |
| | | | arated) | | |

| | | | | |
|---|---|---|---|---|
| Thermal conductivity | 0.44 | 0.44 | 0.43 | 0.45 |
| (W/mK) | | | | |

As can be seen in Table 2, the adhesives prepared in Examples showed a thermal conductivity of at least 0.40 W/mK similar that of the adhesive prepared in Comparative Example 1.

Meanwhile, the adhesives prepared in Examples 1 and 2 showed a higher adhesion strength than 1000 g/in at room temperature and maintained high adhesion near 80° C., the maximum acceptable operating temperature of plasma displays. And, these adhesives showed a smooth reduction in adhesion strength at a temperature of less than 145° C., and had a nearly zero adhesion at 150° C. so as to be separated easily from the substrate.

The adhesive prepared in Example 3 using the organic crystalline material having a low melting point of about 120° C. showed a rapid reduction in adhesion strength sensitively to temperature, but maintained reasonably high adhesion strength near 80° C., the maximum acceptable operating temperature of plasma displays. Also, it reached zero adhesion near 120° C. so as to be releasable.

The adhesive prepared in Comparative Example showed a slight reduction in adhesion strength with an increase in temperature, but was not completely released only by the increase of temperature, unlike the adhesives prepared in Examples.

### INDUSTRIAL APPLICABILITY

The adhesive composition and adhesive sheet of the present invention contain an organic crystalline material having a higher melting point than the maximum acceptable operating temperature of products where the adhesive is used. Thus, below the maximum acceptable operating temperature of products where the adhesive is used, the adhesive composition and adhesive sheet of the present invention maintain excellent adhesion property, but at a higher temperature than the maximum acceptable operating temperature of the products, they show a rapid reduction in adhesion strength so as to allow easy release from substrates. Accordingly, for example in the plasma display panels with strict performance requirements on the adhesion strength and thermal conductivity, etc., the adhesive composition and adhesive sheet of the present invention not only function as a heat dissipating and supporting material but also are released easily from the substrates in reprocessing operations so as to allow the safe separation of electronic parts.

1. An adhesive composition comprising an adhesive polymer resin and an organic crystalline material having a higher melting point than the maximum acceptable operating temperature’ of products where the adhesive is used:

2. The adhesive composition of claim 1, wherein the adhesive polymer resin is an acrylic polymer resin.

3. The adhesive composition of claim 2, wherein the acrylic polymer resin is a copolymer of a (meth)acrylic ester monomer having an alkyl group of 1-12 carbon atoms and a polar monomer copolymerizable with the (meta)acrylic ester monomer.

4. The adhesive composition of claim 3, wherein the (meta)acrylic ester monomer is selected from the group consisting of butyl(meth)acrylate, hexyl(meth)acrylate, n-octyl (meth)acrylate, isooctyl (meth)acrylate, 2-ethylhexyl(meth)acrylate and isononyl(meth)acrylate.

5. The adhesive composition of claim 3, wherein the polar monomer is selected from the group consisting of (meth)acrylic acid, malefic acid and fumaric acid, acrylamide, N-vinylpyrrolidone and N-vinylcaprolactam.

6. The adhesive composition of claim 3, wherein the ratio of the (meth)acrylic ester monomer to the polar monomer is 99-80:1-20.

7. The adhesive composition of claim 1, which 35 further comprises at least one filler selected from the group consisting of a thermally conductive filler, a flame-retardant filler, an antistatic agent, a foaming agent and a polymeric hollow microsphere.

8. The adhesive composition of claim 7, wherein the filler is contained at an amount of 50-200 parts by weight to the 100 parts by weight of the adhesive polymer resin.

9. The adhesive composition of claim 7, wherein the thermally conductive filler is selected from the group consisting of metal oxide, metal hydroxide, metal nitride, metal carbide and boron compounds.

10. The adhesive composition of claim 1, wherein the organic crystalline material is contained at an amount of 1-50 parts by weight to the 100 parts by weight of the adhesive polymer resin.

11. The adhesive composition of claim 1, wherein the melting point of the organic crystalline material is at least 10° C. higher than the maximum acceptable operating temperature of products where the adhesive is used.

12. The adhesive composition of claim 1, wherein the organic crystalline material has a melting point of 50-200° C.

13. The adhesive composition of claim 1, wherein the organic crystalline material has a molecular weight of less than 3,000.

14. The adhesive composition of claim 1, wherein the organic crystalline material has a size of 1-50 μm.

15. The adhesive composition of claim 1, wherein the organic crystalline material is selected from the group consisting of 3-(hydroxyphenylphosphinyl)propanic acid (HPP; CgH1109P), 9,10-dihydroxy-9-oxa-10phosphaphenanthrene-10-oxide (DOPO; C12H902P), tris(3hydroxypropyl)phosphin oxide ((HO—C₃H₆)₃PO), aromatic polyphosphoric ester oligomer (PX-200), triphenylphosphoric acid, bisphenol A and metaterphenyl.

16. An adhesive sheet prepared by applying the adhesive composition of claim 1 to one or both sides of a sheet.

17. A method for preparing an adhesive composition comprising an adhesive polymer resin and an organic crystalline material having a higher melting point than the maximum acceptable operating temperature of products where the adhesive is used, the method comprising a step of mixing the organic crystalline material with the adhesive polymer resin, and a step of polymerizing the mixture.

18. The method of claim 17, wherein the mixing step further comprises a step of partially polymerizing monomers for forming the adhesive polymer resin so as to form a polymer syrup with a viscosity of 1,000-10,000 CPS, and a step of adding the organic crystalline material to the above-obtained polymer syrup.

19. The method of claim 18, wherein, in the step of adding the organic crystalline material to the polymer syrup, at least one filler selected from the group consisting of a thermally conductive filler, a flame-retardant filler, an antistatic agent, a foaming agent and a polymeric hollow microsphere is added.
